(19) United States
(12) Patent Application Publication
(10) Pub. No.: US 2006/0291083 A1
(43) Pub. Date: Dec. 28, 2006

(54) Cinematic media content storage system including a digital storage memory module

(75) Inventor: Mark Jankins, Studio City, CA (US)

Correspondence Address: FITCH EVEN TABIN AND FLANNERY, 120 SOUTH LA SALLE STREET, SUITE 1600, CHICAGO, IL, 60603-3406, US

(73) Assignee: Digi-Flicks International, Inc.

(21) Appl. No.: 11/166,796

(22) Filed: Jun. 24, 2005

(51) Int. Cl. G11B 5/02

(52) U.S. Cl. 360/55

(57) ABSTRACT

Pursuant to these various embodiments, a cinematic media content storage system can be comprised of a memory module interface (503 and 504) and at least one digital storage memory module (100). The memory module interface is preferably configured and arranged to compatibly mechanically and electrically couple with the memory module interface. The memory module interface itself preferably comprises a housing (101) (which preferably comprises a ruggedized housing), a memory (102) (which preferably comprises a hot-swappable disk drive such as a hot-swappable SATA disk drive), an impact absorber (103) that is disposed between the memory and the housing, and a memory output interface (104) that operably couples to the memory and which is accessible external to the housing. In a preferred approach this memory output interface comprises, at least in part, a high repetition cycle connector.

### TECHNICAL FIELD

This invention relates generally to the storage (and corresponding conveyance) of cinematic media content and more particularly to the storage of digital cinematic media content.

### BACKGROUND OF THE INVENTION

Cinematic media content is well known in the art and typically comprises both visual imagery and synchronized audio material that is intended for public presentation and display in a theater setting before a potentially large audience. In general, so-called film prints serve as the storage, conveyance, and presentation vehicle for cinematic media content. Reels of such prints are typically physically conveyed from a point of distribution to a theater. A compatible projector then displays the corresponding cinematic media content on a presentation screen.

Such prints comprise an analog solution (for the most part; some prints include audio information in digital form) and therefore incur the fragility that characterizes such a medium. For example, film prints typically experience wear and tear with each showing. Over time, the resulting projected image becomes less pristine due to accumulated scratches, chemical changes, and breakage. Projection equipment also tends to be relatively complicated. This, in turn, tends to lead to a need for trained and skilled personnel to properly operate the projector when using film prints.

Digital versions of audio-visual content are of course known. Audio-visual content delivered via the Internet comprises one relatively ubiquitous example as are digital video discs (DVDs). Technically speaking, the means exist to convey cinematic media content in digital form to a presentation venue (via, for example, a satellite link) and to then project that content onto a screen. Notwithstanding this technical feasibility, however, numerous challenges nevertheless remain.

For example, counterfeiting and/or unauthorized sale and distribution of cinematic media content comprises a large and growing problem worldwide. There is a general perception that digitized content can be more easily appropriated and, once appropriated, can be more readily employed to create a virtually endless supply of essentially perfect unauthorized copies. Concerns such as this have likely contributed to the relative slowness of the movie industry to adopt more aggressively the digital storage and conveyance of cinematic media content.

Encryption comprises the primary basis of present efforts to render digital storage of cinematic media content a viable commercial possibility. In theory, well-encrypted digital content should prevent an unauthorized party from obtaining a usable (i.e., copyable) copy of the corresponding cinematic content. In practice, however, numerous problems and concerns continue to trouble the potential users of such a system. As a result, in practice, encryption does not appear, at least in and of itself, to be a satisfactory answer.

### BRIEF DESCRIPTION OF THE DRAWINGS

The above needs are at least partially met through provision of the cinematic media content storage system including a digital storage memory module described in the following detailed description, particularly when studied in conjunction with the drawings, wherein:

FIG. 1 comprises a block diagram as configured in accordance with various embodiments of the invention;

FIG. 2 comprises a perspective view as configured in accordance with various embodiments of the invention;

FIG. 3 comprises a front elevational view as configured in accordance with various embodiments of the invention;

FIG. 4 comprises a block diagram as configured in accordance with various embodiments of the invention;

FIG. 5 comprises a front elevational view as configured in accordance with various embodiments of the invention; and

FIG. 6 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a cinematic media content storage system can be comprised of a memory module interface and at least one digital storage memory module. The memory module interface is preferably configured and arranged to compatibly mechanically and electrically couple with the memory module interface. The digital storage memory module itself preferably comprises a housing (which preferably comprises a ruggedized housing), a memory (which preferably comprises a disk drive (and most preferably a SATA and/or a hot-swappable disk drive), an impact absorber that is disposed between the memory and the housing, and a memory output interface that operably couples to the memory and which is accessible external to the housing. In a preferred approach this memory output interface comprises, at least in part, a high repetition cycle connector.

So configured, this cinematic media content storage system comprises a relatively robust and simple-to-use offering. Cinematic content can be readily and securely conveyed via physical transport of the digital storage memory module(s). The latter are relatively small as compared to film prints. They are also highly reusable and therefore promise not only higher quality but reduced costs as well. This system is also readily usable by relatively (or minimally) trained personnel.

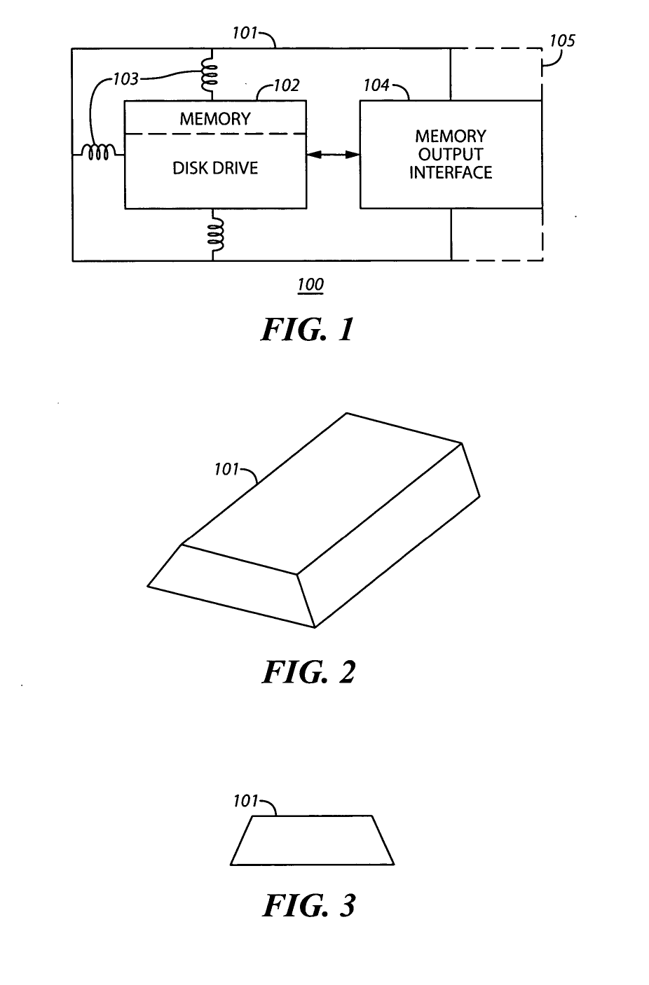

These and other benefits may become clearer upon making a thorough review and study of the following detailed description. Referring now to the drawings, and in particular to FIG. 1, an illustrative digital storage memory module 100 preferably comprises a housing 101. Because of the anticipated high degree of reuse, and further in view of the likelihood that these digital storage memory modules 100 will be transported back and forth between downloading centers, points of distribution, and theaters by a variety of carrier services, this housing 101 preferably comprises a ruggedized housing. For example, and pursuant to an optional but preferred approach, this housing is comprised of computer numerically controlled aircraft-grade aluminum as exists in the art. Though this material is considerably stronger than a typical hard drive housing, such material here anticipates the duration and type of use and transport that these housings are likely to experience.

The digital storage memory module 100 further preferably comprises a memory 102 that is disposed within the housing 101. In a preferred approach this memory 102 comprises a disk drive. In a more preferred embodiment this disk drive comprises a hot-swappable disk drive as is known in the art.

In a more preferred embodiment this disk drive comprises a SATA disk drive, where “SATA” refers to Serial Asynchronous Transfer Attachment (also known as Serial ATA) and specifies, in particular, a serial link comprising a single cable having a minimum of four wires that creates a point-to-point connection between devices. (Transfer rates for Serial ATA begin at 150 MBps and SATA II offers transfer rates of 300 MBps.) One of the main design advantages of Serial ATA over, for example, Parallel ATA is that typically thinner serial cables facilitate more efficient airflow inside a given form factor and also allow for smaller chassis designs. In a preferred embodiment, however, the SATA disk drive as used herein will lack connecting cables for either power or data transfer purposes (aside from such cables as may be used to couple the memory 102 to a memory output interface 104 as is disclosed below). In a preferred approach the disk drive plugs into a non-cable connector that is in turn mounted on a printed wiring board. This design would tend to prevent any damage to the printed wiring board when, for example, an untrained person inserts the disk drive into a receiving bay with undue force.

As noted above, a preferred disk drive comprises a hot-swappable disk drive. A most preferred disk drive, then, will comprise a hot swappable SATA disk drive as is and/or will soon be available from SATA disk drive providers or distributors.

As noted above, the housing 101 preferably comprises a ruggedized housing. In a preferred approach, the digital storage memory module 100 further comprises at least one impact absorber 103 that is disposed between the memory 102 and the housing 101 (effectively, if not literally). This could comprise any impact absorber (such as one or more springs) but which will comprise, in a preferred approach, impact absorbing silicon as is known in the art. Such material can be disposed in a manner such that it essentially largely or even wholly encapsulates the memory 102 to thereby aid in preserving the memory 102 from damage during transit, installation, or use. For example, in a preferred approach, an initially-liquid silicon material can be dispensed about and around the memory 102 and then appropriately cured (using time and/or temperature as appropriate) to cause the silicon material to become more solid. (Such materials are well known in the art and require no further elaboration here.)

Lastly, and again pursuant to a preferred approach, the digital storage memory module 100 comprises a memory output interface 104. This memory output interface 104 operably couples to the memory 102 and is positioned so as to be accessible external to the housing 101 (though preferably mounted in a fixed manner and/or otherwise appurtenant to the housing 101). This memory output interface 104 serves to provide power to the memory 102 and further to provide a data path to permit the downloading of cinematic media content from the memory 102.

In a preferred approach this memory output interface 104 comprises, at least in part, a high repetition cycle connector. For example, this connector can comprise a connector that is designed for at least 10,000 insertion and removal cycles. Ordinarily such high repetition cycle connectors, though known in the art, are not employed in conjunction with hard drives as the hard drives are typically viewed as only being occasionally connected/disconnected during an expected lifetime of use.

By one approach, this memory output interface 104 can extend somewhat beyond the general external periphery of the housing 101. By another approach, and again to aid with respect to anticipated robustness, the housing 101 may extend about and essentially encompass the memory output interface 104 as is suggested by the phantom lines shown in FIG. 1 and denoted by reference numeral 105. This, in turn, can further aid to ensure the viability of the resultant digital storage memory module notwithstanding what amounts to frequently aggressive transport and operational conditions.

So configured, the digital storage memory module is well suited to serve as a suitable means of conveying cinematic media content to movie theaters. The memory 102 itself can be sized as appropriate to match the storage requirement needs of a given distributor. The overall apparatus will likely survive the rigors of transport (including transport by any number of conveyance mechanisms as are presently known or as may be hereafter developed). This apparatus will further likely interface in an uncomplicated and straightforward manner with a corresponding port.

As to the latter, if desired and referring now to FIGS. 2 and 3, the housing 101 can have a trapezoidally-shaped lateral cross-section. The potential benefits of such a configuration will be made clearer below when describing a corresponding memory module interface.

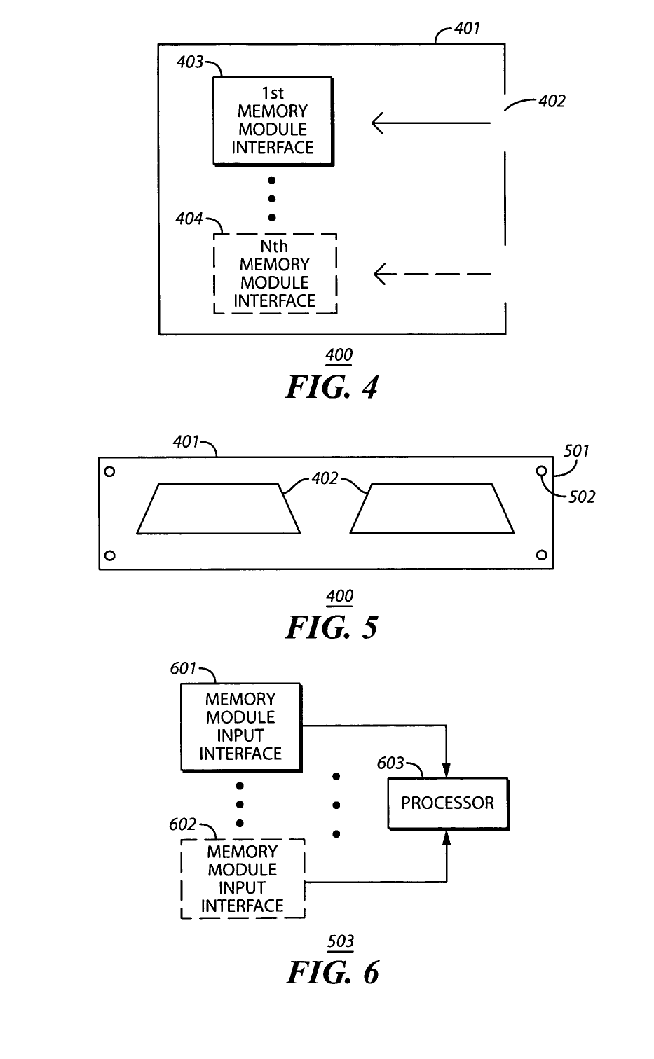

Referring now to FIG. 4, a memory module port 400 will be described. A preferred embodiment of the memory module port 400 will typically comprise a housing 401 having at least one access cavity 402 through which a digital storage memory module (not shown) can be disposed. With momentary reference to FIG. 5, these access cavities 402 can comprise trapezoidally-shaped openings. So configured, a corresponding digital signal memory module having a trapezoidally-shaped cross-section as disclosed above will be effectively keyed to the trapezoidally-shaped opening of the memory module port 400. This, in turn, will assist in preventing even an inexperienced and untrained individual from successfully inserting a digital storage memory module into the memory module port 400 in other than a correct manner. This, in turn, will assist in ensuring that the memory output interface of the digital storage memory module will correctly meet and mate with a corresponding memory module interface 503 or 504. (This will also prevent parts of the memory module or memory module port from being damaged by attempting to incorrectly place the memory module into the memory module port, thus contributing to the overall robustness of the system.)

In a typical deployment, the memory module port 400 may be rack mounted. Accordingly, the housing 401 may further be provided with rack mounting holes 502. In accordance with well understood prior art technique, these rack mounting holes 502 are preferably disposed through so-called rack-mount ears 501 as are formed on either side of the housing 401.

Returning again to FIG. 4, this housing 401 also contains at least one memory module interface 403 and, more preferably, a plurality of such memory module interfaces (represented here by an Nth memory module interface 404 where “N” comprises an integer larger than “1”). These memory module interfaces 403 and 404 are preferable arranged and configured to compatibly mechanically and electrically couple with a corresponding memory output interface of a given digital storage memory module as has been disposed through a corresponding access opening 402. In an optional but preferred embodiment, these memory module interfaces 403 and 404 further comprise high repetition cycle connectors. For example, as with the digital storage memory modules, these connectors can be designed for at least 10,000 insertion and removal cycles.

Referring now to FIG. 6, each memory module interface (represented here by the first memory module interface 403) may be comprised of a memory module input interface 601 (and preferably a plurality of memory module input interfaces 602) that operably couples to a processor 603. These memory module input interfaces preferably comprise high bandwidth network interfaces (which are known in the art and require no further elaboration here).

The processor 603, in an optional but preferred embodiment, will run a Linux operating system and Samba networking software, with both software examples being well known in the art. More particularly, in a preferred embodiment the processor 603 comprises a Network Attached Storage (NAS) server (which also comprises a well-understood entity).

So configured, the memory module port can receive at least one (and preferably a plurality) of digital storage memory modules that each contain cinematic media content. This content can comprise a complete theatrical presentation (such as a movie) or a plurality of such presentations. This content can further comprise advertising, trailers, and so forth as may be desired. The digital storage memory modules are easily placed within the housing of the memory module port in a manner than encourages proper placement of the digital storage memory module in a way that tends to ensure proper operational engagement. Once placed in this manner the digital storage memory module receives operating power via the memory module port and is able to provide its stored content via the memory module port to any authorized entity on a network (i.e., an entity that is authorized with respect to the network and corresponding security structures) that includes the memory module port.

Those skilled in the art will appreciate the relative ease by which cinematic media content is made available for presentation. Skilled practitioners will also understand and appreciate that the cinematic content carriers (i.e., the digital storage memory modules themselves) are well suited to store and protect such digital content notwithstanding the rigors of modem commercial transport and handling. It will further be understood and appreciated that these elements will likely provide effective service notwithstanding frequent combination and separation of these various components over time. In sum, these teachings essentially facilitate a mode of cinematic content delivery that has, until now, been essentially eschewed by those skilled in the art.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, the cinematic media content may be partially or wholly encrypted (or not) depending upon the needs and/or requirements of a given application setting.

We claim:

1. A cinematic media content storage system comprising:
at least one digital storage memory module comprising:
a housing;
a memory disposed within the housing, wherein the memory comprises a hot-swappable disk drive;
at least one impact absorber disposed between the memory and the housing;
a memory output interface operably coupled to the memory and being accessible external to the housing, wherein the memory output interface comprises, at least in part, a high repetition cycle connector;
a memory module interface comprising:
at least one memory module input interface that is arranged and configured to compatibly mechanically and electrically couple with the memory output interface of the digital storage memory module.

2. The cinematic media content storage system of claim 1 wherein the housing comprises computer numerically controlled aircraft-grade aluminum.

3. The cinematic media content storage system of claim 1 wherein the hot-swappable disk drive lacks connecting cables for either of power and data.

4. The cinematic media content storage system of claim 3 wherein the at least one memory module input interface provides power and data interfaces for the digital storage memory module via the high repetition cycle connector.

5. The cinematic media content storage system of claim 1 wherein the impact absorber comprises, at least in part, impact absorbing silicon.

6. The cinematic media content storage system of claim 1 wherein the high repetition cycle connector comprises a connector that is designed for at least 10,000 insertion and removal cycles.

7. The cinematic media content storage system of claim 1 wherein the at least one digital storage memory module lacks any data interfaces that extend beyond an external periphery of the housing.

8. The cinematic media content storage system of claim 1 wherein the housing has a trapezoidally-shaped lateral cross-section and the memory module interface further comprises a housing having at least one trapezoidally-shaped opening formed therein such that the housing is substantially keyed to the trapezoidally-shaped opening.

9. The cinematic media content storage system of claim 1 wherein the memory module interface comprises at least two separate and discrete memory module input interfaces that are each arranged and configured to compatibly mechanically and electrically couple with the memory output interface of the digital storage memory module.

10. The cinematic media content storage system of claim 1 wherein the memory module input interface comprises, at least in part, a high repetition cycle connector.

11. The cinematic media content storage system of claim 1 wherein the high repetition cycle connector comprises a connector that is designed for at least 10,000 insertion and removal cycles.

12. The cinematic media content storage system of claim 1 wherein the memory module input interface further comprises a processor that operably couples to the memory module input interface.

13. The cinematic media content storage system of claim 12 wherein the processor runs both a Linux operating system and Samba networking software.

14. The cinematic media content storage system of claim 12 wherein the processor comprises a Network Attached Storage server.

15. The cinematic media content storage system of claim 12 wherein the memory module input interface further comprises a high bandwidth network interface that operably couples to the processor.

16. The cinematic media content storage system of claim 1 wherein the hot-swappable disk drive comprises a hot-swappable SATA disk drive.

17. A digital storage memory module for use with a cinematic media content storage system comprising:
a housing;
a memory disposed within the housing, wherein the memory comprises a hot-swappable disk drive;
at least one impact absorber disposed between the memory and the housing;
a memory output interface operably coupled to the memory and being accessible external to the housing, wherein the memory output interface comprises, at least in part, a high repetition cycle connector.

18. The digital storage memory module of claim 17 wherein the housing comprises computer numerically controlled aircraft-grade aluminum.

19. The digital storage memory module of claim 17 wherein the hot-swappable disk drive lacks connecting cables for either of power and data.

20. The digital storage memory module of claim 17 wherein the impact absorber comprises, at least in part, impact absorbing silicon.

21. The digital storage memory module of claim 17 wherein the high repetition cycle connector comprises a connector that is designed for at least 10,000 insertion and removal cycles.

22. The digital storage memory module of claim 17 wherein the digital storage memory module lacks any data interfaces that extend beyond an external periphery of the housing.

23. The digital storage memory module of claim 17 wherein the housing has a trapezoidally-shaped lateral cross-section.

24. The digital storage memory module of claim 17 wherein the hot-swappable disk drive comprises a hot-swappable SATA disk drive.

25. A digital storage memory module for use with a cinematic media content storage system comprising:
a housing comprising computer numerically controlled aircraft-grade aluminum;
a memory disposed within the housing, wherein the memory comprises a hot-swappable disk drive that lacks connecting cables for either of power and data;
at least one impact absorber comprising, at least in part, impact absorbing silicon disposed between the memory and the housing;
a memory output interface operably coupled to the memory and being accessible external to the housing, wherein the memory output interface comprises, at least in part, a high repetition cycle connector that is designed for at least 10,000 insertion and removal cycles and which does not extend beyond an external periphery of the housing.
